(19) United States
(12) Patent Application Publication
(10) Pub. No.: US 2024/0018942 A1
(43) Pub. Date: Jan. 18, 2024

(54) ROBOTIC REPAIR SYSTEM

(71) Applicant: ROYAL COLLEGE OF ART, London, Greater London (GB)

(72) Inventors: Rasoul SADEGHIAN, London (GB); Sina SAREH, London (GB)

(73) Assignee: ROYAL COLLEGE OF ART, London, Greater London (GB)

(21) Appl. No.: 18/032,139

(22) PCT Filed: Oct. 15, 2021
(86) PCT No.: PCT/GB2021/052686

§ 371 Date: Apr. 14, 2023

(30) Foreign Application Priority Data
Oct. 15, 2020 (GB) 2016390.3
Jun. 16, 2021 (GB) 2108618.6

(51) Int. Cl. F03D 80/50; B62D 57/032; B62D 57/024; B25J 11/00; B25J 15/00

(52) U.S. Cl. CPC F03D 80/50; B62D 57/032; B62D 57/024; B25J 11/0085; B25J 15/0019; F05B 2230/80; F05B 2270/8041

(57) ABSTRACT

An integrated robotic repair system for repairing a surface is described. The said system comprising: a base translation system (110), said system comprising a multistage platform; a repair module (150), said module coupled to the translation system (110) to move the module (150) relative to the base translation system (110); an end effector selector system coupled to the repair module, said selector system comprising end effector repair tools (360, 362, 366), each tool (360, 362, 366) configured to undertake a repair task on the surface; and deployable legs (120), said legs (120) coupled to the base translation system (110) and configured to engage and disengage from the surface to allow the system to walk along surface.

### FIELD

The present invention relates to a robotic repair system, and in particular to a robotic repair system for repairing or restoring surfaces.

### BACKGROUND

Infrastructure repair of surfaces, particularly difficult to access surfaces such as wind turbine blades, pipes (such as oil or gas pipelines), roofs or any other flat or curved surfaces is an ongoing concern. This is particular the case where access presents risk of injury to the repairer and the possibility of significant downtime for the infrastructure. One example of such infrastructure is wind turbines. Wind turbines provide renewable energy by harnessing wind power that propels turbine blades, which in turn rotates a generator to generate electricity that can be stored on sent to a national grid system. While the generator, tower and hub of wind turbines are typically manufactured from metals, composite materials are widely used in the construction of blades and nacelles. Accordingly, the wind turbine blades are subject to degradation and damage due to the complex loading on the blade (including object impacts), which can lead to blade erosion.

Whilst on-shore turbines can be inspected and scaled relatively easily, the inspection and repair of offshore wind turbines is typically performed by rope access technicians. As noted above, the challenging offshore conditions provide a multitude of risks including lightning strikes, squalls and gales, as well as wave heights that make transfer of the technicians from vessels to the wind turbine platforms highly dangerous even before the turbine itself is scaled. 2019 incident data report by the G+ Global Offshore Wind Health & Safety Organization reported on 252 high incidents with potential to cause a fatality or life-changing injury. The incidents were predominantly associated with working at height and lifting operations.

Global capacity of wind farms is predicted to double in the next five years, and wind turbine blades are also expected to get larger than the current 80 m long. poses limitations with respect to access and performance.

Similar issues and concerns arise in the maintenance of pipes, building roofs and external walls or other surfaces prone to degradation. For this reason, interest in robotic repair solutions has been growing. To this end, mobile telemanipulation systems can be employed to enable remote operations in hazardous environments. A mobile robotic manipulation system typically consists of a robot arm integrated into a moving or mobile platform presenting a dual advantage of manipulation dexterity and an unlimited workspace.

Prominent examples with a focus on blade inspection and repair include Sandia National Labs, USA, and Rope Robotics Ltd, Denmark. Currently this involves integrating ground-based robotic arms into mobile platforms. However, adding a range of required application specific capabilities to a manipulation system usually comes at the cost of increased weight, size and power requirements thereby reducing the amenability for integration into the state of-the-art mobile robotic platforms. Accordingly, current solutions rely on the robotic system being suspended on ropes from the wind turbine structure, with the movement of the robotic system being constrained along the ropes. However, this necessitates the installation of ropes by human users prior to operation, which still exposes such workers to the risks identified above.

The present invention aims to solve or at least ameliorate the problems associated with the aforementioned systems.

### SUMMARY

According to a first aspect of the invention, there is provided an integrated robotic repair system for repairing a surface, said system comprising: a base translation system, said system comprising a multistage platform; a repair module, said module coupled to the translation system to move the module relative to the base translation system; an end effector selector system coupled to the repair module, said selector system comprising end effector repair tools, each tool configured to undertake a repair task on the surface; and
deployable legs, said legs coupled to the base translation system and configured to engage and disengage from the surface to allow the system to walk along the surface.

The surface may be a flat or curved surface. The surface may be the surface of an infrastructure installation, such as pipes, roofs, or blades. In an embodiment the surface is a blade of a wind turbine.

In embodiments the deployable legs may comprise attachment means for releasably engaging the repair system to the surface. The attachment means may comprise suction discs. The suction discs may comprise a plurality of suctions cups, said cups provided between an inlet sealing block and a contact surface sealing block. The suction cups may be configured to engage the surface by compressing the inlet sealing block towards the contact surface sealing block.

The multistage platform in embodiments may comprise a first translation stage and a second translation stage, wherein the repair module is coupled to the first translation stage and is translatable in a first single axis.

The repair arm typically comprises 4 degrees of freedom that allow the arm to access all points within the stage to repair the area of the surface in question.

The first translation stage may be coupled to the second translation stage and is translatable in a second single axis perpendicular to the first axis. Accordingly, in combination the repair module has access to all points in space along the surface on which the system is placed.

In some embodiments the deployable legs may be hingedly attached to the attachment means. The deployable legs may comprise motorised hinged connections to allow the legs to extend and retract. This can allow the robot to form a compact arrangement for transport and the like, or if inclement weather (such as high wind) is encountered during use on the surface such as a wind turbine blade. Additionally, this allows the system to be transformed between a stationary platform to a mobile platform.

The legs may further allow the multistage platform to be moved both vertically towards and away from the surface and further allow the repair system to be moved across the surface of the blade.

In embodiments the deployable legs may comprise attachment means for releasably engaging the repair system to the surface, such as the wind turbine blade. The attachment means may comprise suction discs. The suction discs may comprise a plurality of suctions cups, said cups provided between an inlet sealing block and a contact surface sealing block. The suction cups may be configured to engage the surface of the pipe, wind turbine blade or the like by compressing the inlet sealing block towards the contact surface sealing block. The inlet sealing block may be made with a material such as silicone rubber. This can provide conformity to the shape of the inlet to provide better sealing. The contact surface sealing block may be made from a soft material, such as a foam material and further such as a EPDM foam material.

The attachment means is broadly a multi-modal anchoring module. Said module may comprise 2 or more mechanisms for attachment of the system to a surface. For example, the module may comprise suction means such as cups of the suction discs, grappling hooks, magnets or micro or nano structure elastomeric surfaces. Said mechanisms for attachment may comprise one or more mechanisms, for example 3 suction cups on each leg and combinations of such mechanisms may be used.

The suction means may be engaged in a suction attachment mode of the system. In such mode the system may provide negative pressure to attach the suction cups to the blade. Alternatively a compression mechanism may be used that presses the suction cup against the blade surface. The compression mechanism may be the weight of the system, or may include an active motorised compression arrangement that presses the suction cup against the surface.

The repair module may comprise a repair arm, said repair arm extending within the base translation system to present the end effector repair tool on the surface.

According to another aspect of the invention, there is provided a robotic repair system for use with a mobile robotic platform to remotely repair surfaces. The system comprises a repair arm, said arm comprising a plurality of joints for manoeuvring the arm; a plurality of end effector repair tools, each repair tool configured to service or repair a surface, for example the surface of a composite wind turbine blade or of a pipe, or a roof, or other surface; a toolbox for storing the plurality of end effector repair tools; and wherein the arm comprises a tool change mechanism located at a terminal end and configured to retrieve the repair tools from the toolbox and install them onto the arm.

The repair arm may comprise a rotary tool selection system, said system rotatable to allow the desired end effector repair tool to be presented to the surface.

The present invention further describes a robotic repair system that comprises a plurality of repair tools suited to repairing surfaces such as on remote infrastructure installations, further such as wind turbine blades in inhospitable locations. The system has a repair arm that is able to select a repair tool suited to the repair task required, with the system storing the repair tools within a collocated toolbox. This configuration allows the arm to be lightweight, with each repair tool being only mounted to the terminal end of the repair arm when needed. This aids the manoeuvrability of the arm and allows the weight of the repair tools to be distributed away from the arm (when tools are not in use).

In particular, the present system provides for: Multi-functionality—the ability to switch between multiple repair tasks quickly, e.g. within the overall time constraint of repair material reaction and curing process; Light-weighting: the repair arm should meet the payload requirements of the UAV. The UAV payload include a crawling robot integrated with the repair arm as well as an imaging system for defect detection. In embodiments the weight of the arm is 2 kg; Amenability for modular integration: the arm should be integrateable into a wide range of mobility platforms, e.g. crawlers, as well as a standalone system to enable laboratory testing without the need for a mobile platform; Autonomy: The ability for on-board sensing, decision making and execution, particularly for the tasks that can be negatively impacted by network delay when off-board processors used; Human-in-the-loop operation and override of commands: while the repair mission can be designed to be autonomous in part, keeping human in the loop via a user interface (console) is not only essential for safety reasons, but also can enable direct incorporation of technician's tacit knowledge into the process; and Manipulability: the ability of the arm's end-effectors to reach to different required positions on the blade, within the defined region for repair, is an important design consideration.

In an embodiment, the repair arm may comprise a mounting mechanism for installing the robotic repair system to a mobile robotic platform. This allows the system to be integrated with a mobile robotic platform. As noted above, by keeping the arm as lightweight as possible, installation and manoeuvrability of the mobile robotic platform is easier. The mobile robotic platform may be an unmanned aerial vehicle or a crawler.

Additionally the system may further comprise a vacuum mounting for mounting the system to a surface. This can provide additional stability to the system and it can also be used for testing and mounting the system to surfaces. The suction cup may have a loading capacity of up to 20 kg, although values about this figure could be designed as needed.

The mounting mechanism may also or alternatively comprise screws or the like to permanently fix the system to a mobile robotic platform. Utilising both can allow fast and easy arm installation across a wide range of application scenarios.

In embodiments, the plurality of joints of the repair arm may comprise revolute joints. The revolute joints each provide a rotational degree of freedom for the terminal end of the arm. Typically the repair arm may comprise a plurality of linkages, and each revolute joint acts to connect two linkages together. In a preferred embodiment the repair arm may comprise 5 revolute joints. This can give 2 or more degrees of freedom for the repair arm. The tool change mechanism may be connected to a tip of the repair arm by a rotational joint that allows for rotational movement of the tool change mechanism, and by connection, the installed repair tool. This can allow the repair tool to be orientated to face any direction when moved along the surface of the blade.

The end-effector repair tools may comprise a cleaning end-effector for performing a cleaning task. The cleaning task may include removal of loose materials and wet cleaning of the surface of the blades. The cleaning end-effector may comprise a controllable dispenser for metering cleaning liquid; and a rotary cleaning device driven by a motor. The controllable dispenser may further comprise a metering motor for actuating the dispenser, and wherein position information from the motor and metering motor allow control of a release rate of the cleaning liquid to the rotary cleaning device and a rotational speed of the rotary cleaning device according to the cleaning task. This can allow the dispense of cleaning material to be tailored according to the cleaning task and the speed of rotation of the rotary tool for efficient cleaning and resource usage. The cleaning end-effector may comprise a drum that uses a stiffness-gradient architecture in its mechanical structure, where it has a rigid shaft covered by a layer of silicone rubber as a middle layer and a layer of soft microfiber materials as the outer layer to conform to the curved surfaces and damaged areas for a better cleaning.

The end-effector repair tools may comprise a sanding end-effector for performing an abrasive task such as sanding damaged chamfers of the blades. The sanding end-effector typically comprises a rotary sanding device, such as a sanding drum having sandpaper on the drum's external surface. Rotation of then sanding drum is typically driven by a motor.

The end-effector repair tools may comprise a filler deposition end-effector for performing a filling task. The filler deposition end-effector may comprises an active mixer for mixing filler, said active mixer comprising a motor; a nozzle for applying the filler to the blade according to the filling task, wherein the nozzle is a soft slit nozzle that conforms to the curvature of the blade; and a proximity sensor for measuring a deposition thickness of the filler and to interrupt the motor once a desired thickness according to the filling task is reached. The use of an active mixer can presents significant improvements on space-saving aspects (as opposed to equivalent passive mixers) and control on the material reaction time.

A spatula end-effector repair tool may also be provided to perform a smoothen task to level and round off deposited filler.

Additionally or alternatively a protective tape end-effector repair tool may be provided having protective tape on a tape moving roller, and a cutting means such as a cutting head driven by a motor, for applying tape to the blade surface and for subsequently cutting tape once the required length has been applied. The taping end-effector may use a dancer drum to enhance tape's tension and increase the quality of taping. It may also use a guillotine mechanism for clean cutting.

In embodiments the toolbox may comprise a retractable end-effector tool holder, said holder comprising resiliently biased jaws for holding one of the end-effector repair tools. The jaws may be actuated by a motor against the resilient bias to release the end-effector repair tool stored within said holder. Alternatively the holder may automatically release the end-effector repair tool on application of pressure against the jaws such as during approach by the tool change mechanism of the repair arm.

In an embodiment, the system may further comprise a casing for housing the toolbox. The casing can house control electronics for the system and may be circular.

The end-effector repair tools may comprise a female connector and the tool change mechanism may comprise a corresponding male connector for releasably retaining the end-effector repair tools onto the arm. The male connector may be configured to retract to receive the female connector on the end-effector repair tool and may also be configured to extend to engage the female connector.

Broadly, the invention comprises a lightweight multifunctional robotic repair arm that can be integrated within a range of existing or designed mobile robotic platform types. The arm typically has integrated end effector repair tools that can perform repair and maintenance tasks such as cleaning, sanding, filling (filler material application) and forming, and protective tape adhesion to the damaged area of the blade.

In embodiments, the arm may be integrated with Wi-Fi cameras (typically two or more with one at the base and one near the terminal end of the articulated section) to allow monitoring of the arm for live streaming of the repair process. Cameras, onboard processors and a controller can be used to determined the amount of required repair materials, including protective tape, to minimize the material waste. This may be achieved by utilising image processing onboard of the repair system to identify defects in the blade such that the system begins a repair operation when a defect is identified, eliminating delay or lag caused by latency or ping issues in any remote control or commands issued by a remote user. Similarly, the system may also retract the arm or end a repair process when the system determines using the image processing that the defect is passed by the arm. This minimises overshoot of the repair process, preventing waste of repair materials.

It can be appreciated that one or more or all end-effector repair tools may be integrated with one or more encoders and/or variable speed motors to enable control on the speed of repair task undertaken by the repair tool.

In embodiments the repair arm may be covered with a flexible and stretchable protective sleeve to protect it against weather conditions. The sleeve may be integrated with sleeve sensors to detect said conditions. The sleeve sensors may comprise stress sensors for detecting sheer strain in the sleeve indicative of the arm being configured in a damaging manner, such as having two linkages aligned in an overly acute angle. This provides redundancy in the event of a failure in the motor or motor encoder that is typically used to identify faults.

Use of active mixed, light-weight mechanisms, and materials help to enable minimization of size and weight of the repair arm and system as a whole.

As noted, one or more cameras for wirelessly transmitting visual images of performance of the repair system to a remote user may be provided. This can provide real-time visual feedback of the performance of the repair system.

A user interface may be provided for providing remote control and/or commands to the repair arm by a remote user. This may enable real-time remote imitation of manipulation patterns demonstrated by the user, step-by-step monitoring of the repair process, detecting potential collision between the arm's end-effector and the blade surface, and overriding the autonomous commands, if required, remotely. This may be enacted using the internet or other wireless protocol for communicating between the user interface and the repair arm. The user interface allows for transfer of the remote user's tacit knowledge of the robotic repair process.

A remote motion imitator for imitating movement of the repair arm through space may also be provided. Said remote motion imitator may replicate the commands and/or remote control provided by the remote user to the user interface in a visual manner to the remote user by visually simulating the commanded movement of the repair arm to the user on the remote imitator. Accordingly, the remote motion imitation may comprise an imitation repair arm that may be a multi segment arm.

The movement of the repair arm through space may be determined using the cameras and/or one or more sensors. Sensors may include proximity sensors to provide collision feedback. The collision detection sensor may include a collision detection sensor for detecting deleterious contact between the repair arm and the blade. The collision detection sensor may be an encoder on a motor of the system that detects overload in the motor.

In embodiments, the toolbox is collocated with the arm. The toolbox may be integrated into the base of the arm. The arm may be bent up to latch onto different repair tools autonomously. This keeps the relative position of the arm and repair tools fixed at times, making the tool-changing more time-efficient, robust and eliminating the need for recalibration.

Traditional machine tooling equipment that are able to automatically change tools are heavy industrial equipment, not suitable for integration into mobile robotic platforms that need to be carried using flying drones to locations at height such as the wind turbine blades or elevated oil & gas pipelines.

It can be appreciated that features described in relation to one aspect or embodiment may be used with other aspects or embodiments. These and other aspects of the invention will be apparent from, and elucidated with reference to, the embodiments described hereinafter.

### BRIEF DESCRIPTION OF DRAWINGS

Embodiments will be described, by way of example only, with reference to the drawings, in which

FIG. 1 illustrates an offshore wind turbine having a turbine blade and a robotic repair system according to the present invention as installed in a repair robot placed on the blade;

FIG. 2 shows the robotic repair robot of FIG. 1;

FIG. 3 shows the robotic repair system of FIGS. 1 and 2;

FIG. 4 shows a casing unit and a toolbox of the repair system of FIG. 3;

FIG. 5 shows a retractable end-effector tool holder of the toolbox of FIG. 4 used to hold end-effector repair tools;

FIG. 6 shows an tool change mechanism for retrieving end-effector repair tool from the tool holder of FIG. 5;

FIG. 7 shows a sanding end-effector for use with the robotic repair system of FIG. 3;

FIG. 8 shows a cleaning end-effector for use with the robotic repair system of FIG. 3;

FIG. 9 shows a filler end-effector for use with the robotic repair system of FIG. 3;

FIG. 10 shows a spatula end-effector for use with the robotic repair system of FIG. 3;

FIG. 11 shows a tape dispenser end-effector for use with the robotic repair system of FIG. 3;

FIG. 12 shows a motion imitator and user interface for replicating movement of the robotic repair system of FIG. 3;

FIG. 13 illustrates a control system for controlling the robotic repair system of FIG. 3;

FIG. 14 illustrates a control system for the motion imitator and user interface of FIG. 12;

FIGS. 15a-15e show a typical repair process enacted by the repair arm of FIG. 3; and

FIG. 16a shows a structure of a ROSIC network;

FIG. 16b shows a ROSIC based telecommunication for the applied ROS based manipulator;

FIG. 16c shows a ROSIC Internet based communication system structure;

FIG. 16d shows an experiment test to control a manipulator based on Internet and online video streaming from it the imitator LCD;

FIG. 16e illustrates Latency between the send and receive the command between the console and the manipulator in different hours of day

FIG. 17a illustrates a robotic system according to an embodiment of the present invention having legs in a deployed position;

FIG. 17b illustrates the repair system integrated with the legs;

FIG. 17c shows the repair system components of FIG. 17b;

FIG. 18 shows the system of claim 17a in a compact position;

FIG. 19a shows a spatula end effector tool;

FIG. 19b shows a sander end effector tool;

FIG. 20a shows a leg having attachment means used with the system of FIG. 17; and

FIG. 20b shows an exploded view of the attachment means.

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar feature in modified and different embodiments.

### DETAILED DESCRIPTION OF EMBODIMENTS

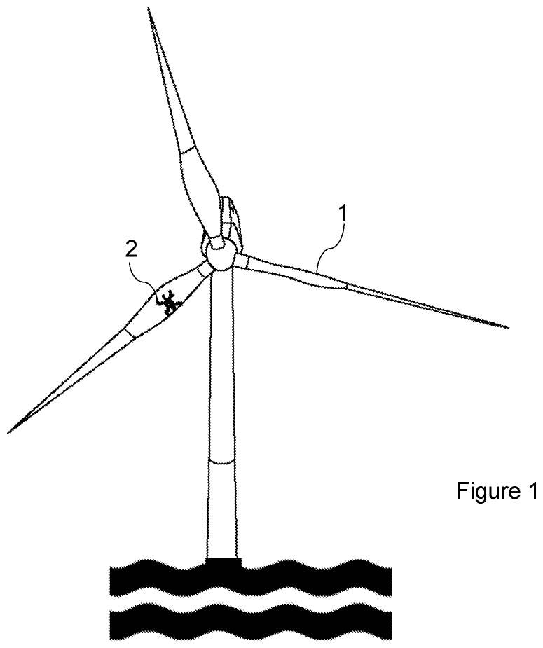

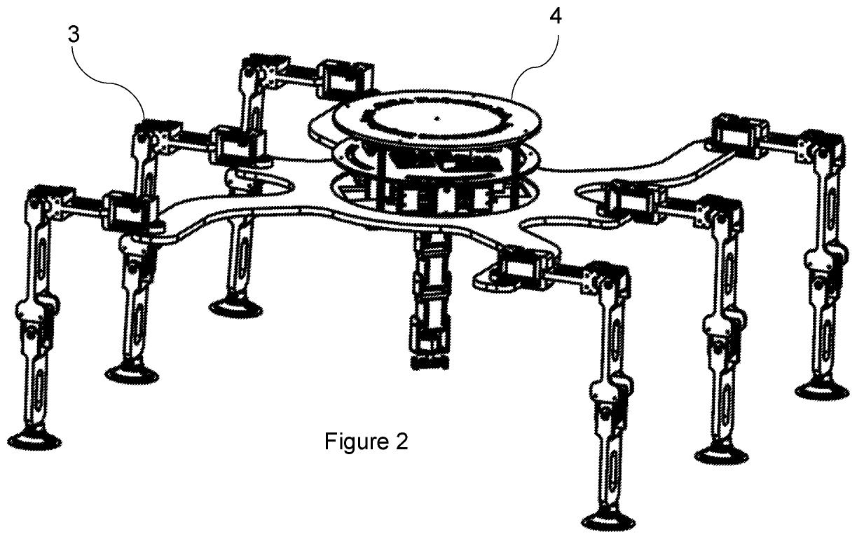

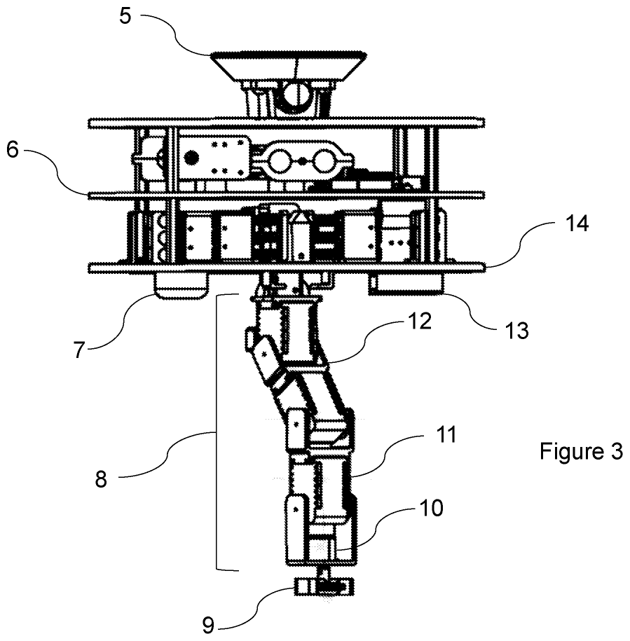

FIG. 1 illustrates an offshore wind turbine 1 with a repair robot placed on a blade 2 of the wind turbine. FIG. 2 shows a close-up of the repair robot, in this instance a crawling robot 3. It can be appreciated that the repair robot may be an alternative mobile platform, such as an unmanned aerial vehicle. Attached to the crawling robot 3 is a robotic repair system 4. The repair system 4 is shown in detail in FIG. 3. In particular, the system 4 comprises a casing unit that houses components of the repair system. A mounting mechanism, in this instance a pump vacuum suction cup 5, for installation of the repair system to flat surfaces is shown. This can be used to anchor the system. The casing unit houses materials, dispensing mechanisms and electronics 6. Also shown is a toolbox 14 that holds a plurality of end-effector repair tools (described below).

Cameras 7, typically Wi-Fi™ cameras are used to monitor performance of the system and to provide real-time feedback to a remote user of the motion and movement of the repair system. The repair system comprises a repair module, such as a repair arm 8 and a tip 9 having an end-effector tool change mechanism 13 that is configured to retrieve repair tools from the toolbox and to install them onto the terminal end of the arm. Also shown is a stepper motor 10 and a servo-motor 11 that are linked by joints 12.

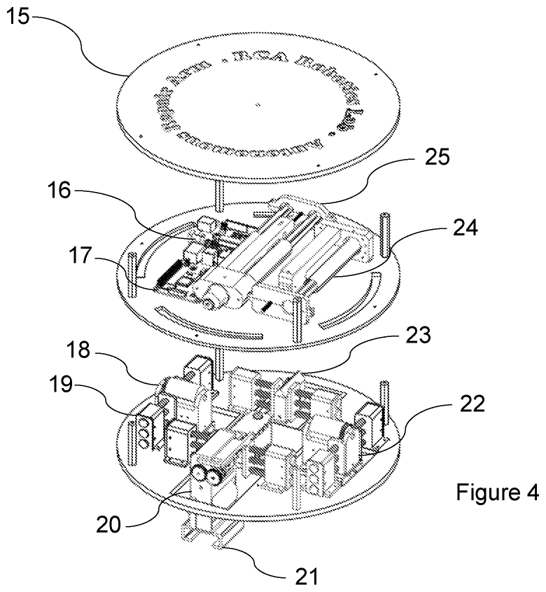

FIG. 4 shows a closer view of the casing unit. The unit comprises a cap plate 15, computing electronics 16, 17 and a number of end-effector repair tools. In particular, a cleaning end-effector repair tool 18 held within a retractable end effector tool holder 19. Additional repair tools may be held in other end-effector tool holders 19, such as a protective tape end-effector repair tool 20.

The casing unit may form a three layer cluster case structured with a top layer 15 that is integrated with the mounting mechanism 5 for arm attachment, a middle layer housing the electronics 16, 17 for communication & control and material supply 24 and dispensing 25 mechanisms, and a base layer which accommodates the end-effector repair tools (toolbox layer). The electronics may be Arduino and/or Raspberry Pi boards or other system on a chip device. The lower layer accommodates retractable clamping end-effector tool holders 19 to hold the end-effector repair tools whilst not in use in the toolbox 14.

As will be described in further detail below, FIG. 4 further shows a female connector 21 attached to said repair tools, a sanding end-effector repair tool 22, a soft-tip slit nozzle filling end-effector repair tool 23, cleaning material dispensing mechanism 24 and repair filling dispenser 25.

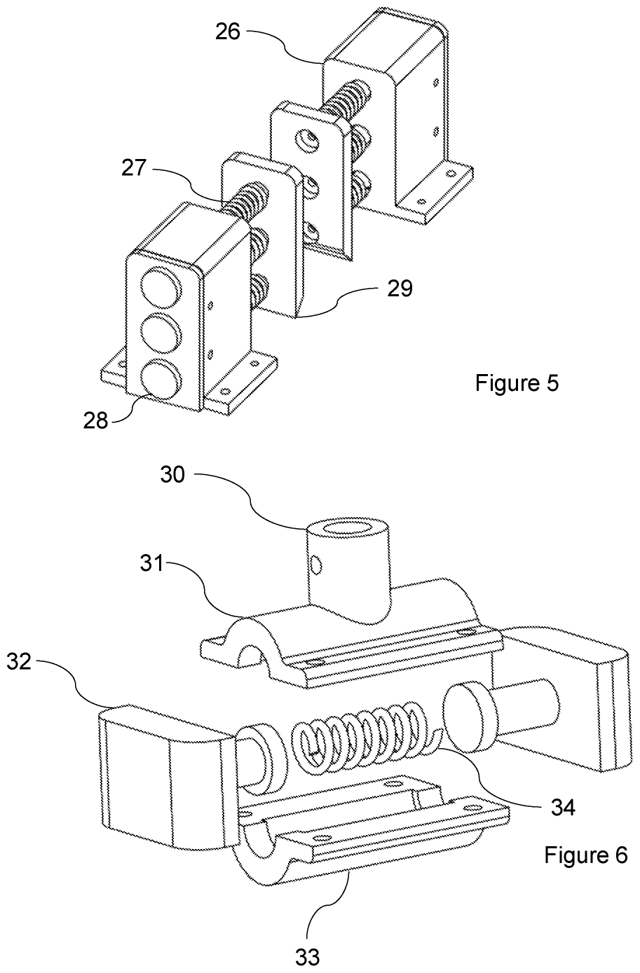

FIG. 5 details the retractable end-effector tool holder 19 of the toolbox 14 of FIG. 4 used to hold end-effector repair tools. The holder 19 comprises a main body 26 and a compression spring 27 to resiliently bias two jaws together that are used to hold an end-effector repair tool therebetween. The jaws comprise a chamfered surface 29 that acts as a surface against which the tool change mechanism on the tip 9 of the repair arm may press to disengage the resilient bias of the jaws to access the retained end-effector repair tool. Use of a passive clamping solution (no electronics) minimises weight and power draw of the device.

FIG. 6 shows the end-effector tool change mechanism 13 (male connector): and features a connection 30 to a step motor, top 31 and bottom 33 housings for a retraction mechanism, compression spring 34 and flaps 32. In use, the tool change mechanism 13 is retracted using the step motor to bias the flaps against the compression spring 34. In this retracted configuration the mechanism is then inserted into a connector of the end-effector repair tool before being released such that the flaps expand due to the spring 34 to bias the flaps 34 outward. Due to the design of the connector of the end-effector repair tools, the flaps engage with surfaces and are too big to pass through the substantially U-shaped gap, engaging the tip 9 of the repair arm 4 with the repair tool. The repair tool may then be manipulated as desired, including by removing from storage within the toolbox, and/or used as intended to undertake a repair.

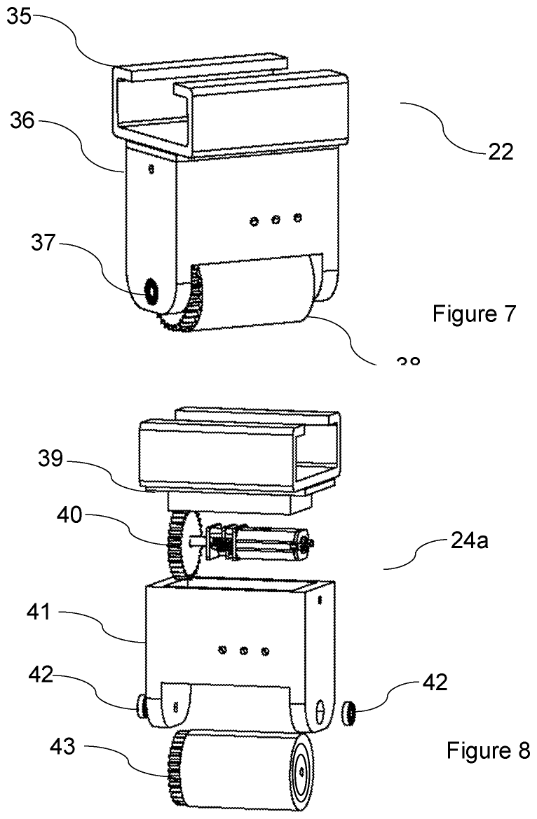

FIG. 7 shows the sanding end-effector repair tool 22 and details a U-shape connector 35 for latching onto the end-effector tool change mechanism in the manner described above, motor and gear box container 36, ball-bearing 37, and a rigid sanding drum covered by sand paper 38. The sanding drum is typically fabricated from rigid PLA materials and the drum's external surface is covered by a layer of sandpaper. In this embodiment two sanding drums with grits of 60 and 80, as advised by TEKNOBLADE REPAIR 9000-material application guidelines may be provided, although alternative grade grits may be selected as desired. In a similar design, the sanding drum may also be actuated by a DC Gear motor with Encoder (12 V, 500 rpm), which enables controlling the of rotation speed when required.

FIG. 8 shows a cleaning end-effector repair tool 24a. This forms a cleaning module in addition to cleaning material dispensing mechanism 24. The cleaning material dispensing mechanism is typically located in the upper level of the system and comprises a controllable dispenser, using a 15gr DC Micro Metal gear motor with Encoder (12V, 100 rpm), to automatically release cleaning liquid. This is fluidly connected using OD flexible tubing (4 mm) to a rotary cleaning end-effector repair tool 24a mountable at the tip 9 of the repair arm 4. The tool 24a a U-shape connector for latching onto the arm 39, motor and gear 40, position of the tubing for cleaning materials 41, and cleaning drum 43 as shown in FIG. 8. The drum is integrated into the casing structure via two metal ball-bearings 42. The cleaning drum 43 is typically covered by a soft microfibre cloth material with thickness of 1 mm at the surface, a 3 mm layer of silicone rubber materials in the middle and a rigid shaft at the centre. This mechanical stiffness-gradient architecture helps conformation of the roller drum 43 onto curved or damaged surfaces of the blade to clean them more effectively. The mechanical design of the drum 43 and the assembly constraints with its casing structure allow a maximum deformation curvature of β=43° on the drum's external surface.

A DC gear motor with Encoder (12 V, 300 rpm) is in charge of moving the drum 43 via an integrated 3D-printed gear. The position information provided by the two motor encoders, within a cleaning liquid dispenser module and the cleaning end-effector repair tool, enables controlling the release-rate of the cleaning liquid to the microfiber material as well as the drum rotational speed to carry out an effective cleaning task. The maximum capacity of the cleaning material dispenser is typically 20 ml.

The position information provided by the two motor encoders, within the cleaning liquid dispenser module 24 and the cleaning end-effector repair tool 24a, enables controlling the release-rate of the cleaning liquid to the microfibre.

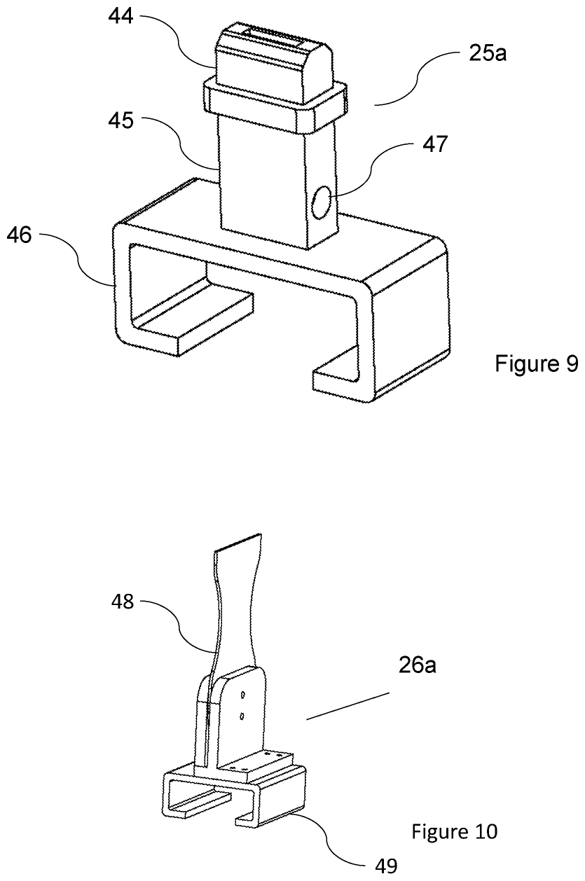

FIG. 9 shows a filling end-effector repair tool 25a that is part of a filler deposition module with the repair filling dispenser 25. This module is configured to dispense and mix material parts of a repair kit (such as the TEKNOBLADE REPAIR 9000-10 kit) and apply it to an identified damaged area, after completion of the sanding and cleaning tasks. Given that weight and moment arms should be minimised, a motorized active mixer is used. The module comprises three parts linked via 4 mm OD tubing and include a two-part material dispenser 25 driven by a DC gear motor (12V, 250 rpm) and equipped with an encoder, that are merged to a single tubing and fed into an active mixer. Subsequently, the mixed material is moved to a slit nozzle 44 that can conform to the surface geometry of the turbine blade 2, filler material container 45, U-shape latching connector 46, and a position for filler material supply 47.

According to the material's technical datasheet, the recommended film thickness of this material (a layer of deposition at time) is 2 mm. In order to ensure this, a proximity sensor which comprises of an optical head FU-69U (Keyence Co., Japan) and a fiber-optic sensor FS-N11MN at locations near the terminal end of the arm continuously measure the deposition depth and interrupt the process if the maximum thickness is exceeded.

FIG. 10 details a spatula end-effector repair tool for flattening of the surface: a spatula 48 and the U-shape connector 49 are shown. The spatula 48 acts to smooth filler material and to restore the geometrical shape of the turbine blade edge being repaired.

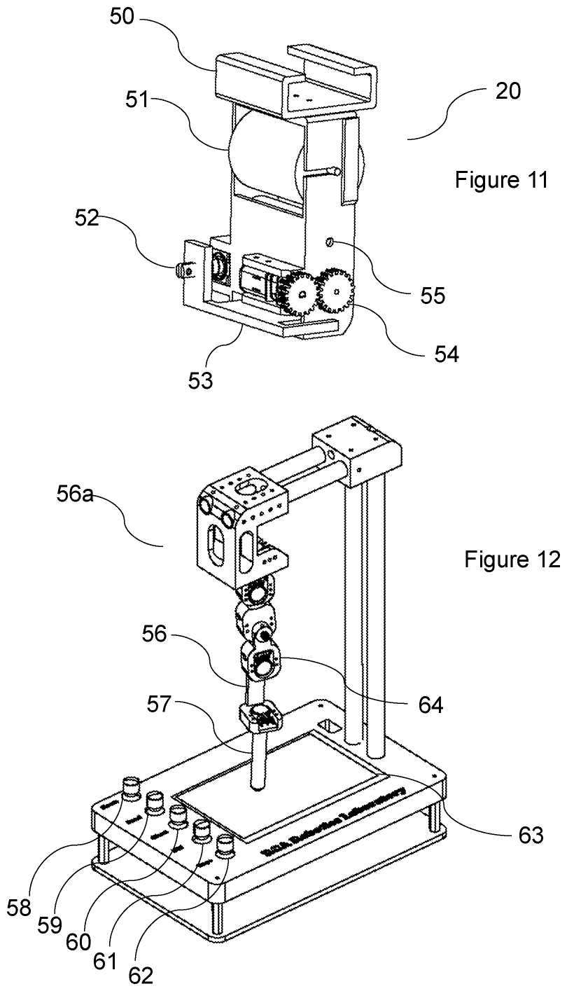

FIG. 11 shows a protective taping end-effector repair tool comprised of tape tensioning and cutting mechanisms: the U-shape connector 50, protective tape 51, solenoid motor for cutting 52, cutting blade head 53, tape moving roller 54, and dancer roller 55.

FIG. 12 shows a motion imitator and user interface according to an embodiment of the present invention. The repair system can include a plurality of cameras and/or sensors to track the movement of the repair arm and the associated end-effector repair tools. FIG. 12 utilises the visual and sensor information derived from the cameras/sensors to map the movement of the repair arm to a scaled multi-segment motion imitator 56. The imitator 56 is configured to replicate the movement of the actual repair arm. Additionally or alternatively a user interface module may be provided to supply remote control to the imitator, which is then correspondingly relayed to the repair arm to remotely control the arm. The user interface has a stylus 57, buttons for moving the arm's end-effector tool changer to specified locations for Home 58, toolbox locations for Cleaning 59, Sanding 60, Filling 61, and safety stop 62 positions. A LCD or similar display panel is used to livestream the repair progress as captured visually by a Wi-Fi camera on the arm, and sensor elements such as a potentiometer 64. The stylus can act to replicate the motion of the repair arm to provide an indicator to the controller. This can allow for direct visual feedback and visualization to the controller in real-time so the controller can monitor the position and status of the repair arm.

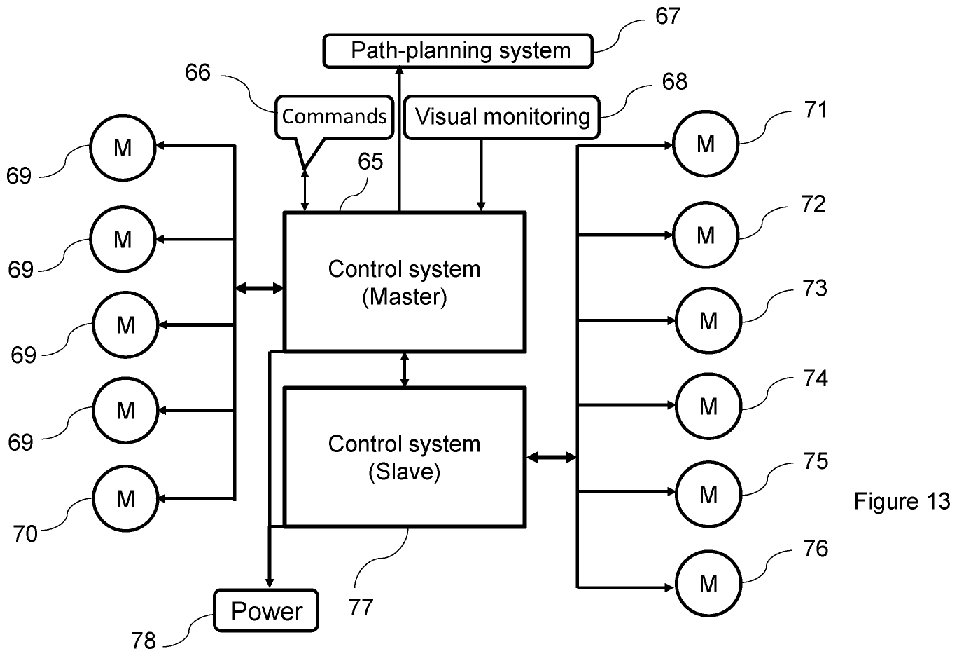

FIG. 13 Details of the arm's control system: The main control unit (master) 65 communicates the commands 66 with the imitator via the Internet communication. The path planning algorithm 67 uses the arms' inverse kinematics and is run within the master control system. The servo motors 69 and a stepper motor 70, which actuate the 5R assembly, are controlled via the master control system. The DC geared encoder motors that are used for filler deposition 71, mixing 72, dispensing cleaning material 73, sanding end-effector 74, cleaning end-effector 75 and taping 76 are controlled by the slave control unit 77. The on-board power system 78 is used to run the motors and control system units.

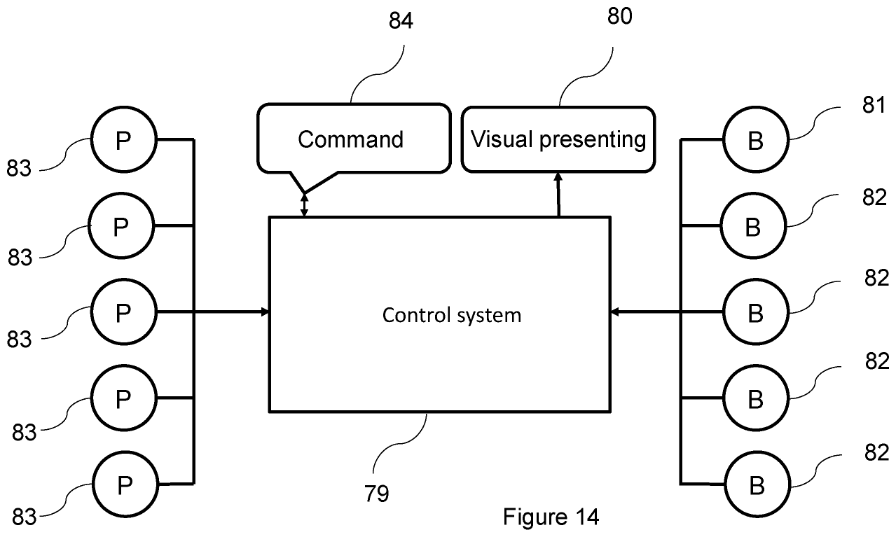

FIG. 14 illustrates schematically details of the control system for the motion imitator and user interface. The user interface system, communicating with the arm through Wi-Fi 84, is comprised of a multi-segment motion imitation tool, a Touch Screen Display for monitoring and visualisation of the repair operations 80, and five self-locking latching buttons 83, which enable sending predefined commands to the arm, under a control system 79. In a setting, there are five predefined functions that can be communicated via the interface buttons, ‘HOME’, ‘SAND’, ‘CLEAN’, and ‘FILL’ 83. When the operator presses any button, the motorized joints of the repair arm (shown as a 5R assembly) will be displaced to position the arm's terminal end in a predefined location 81, 82.

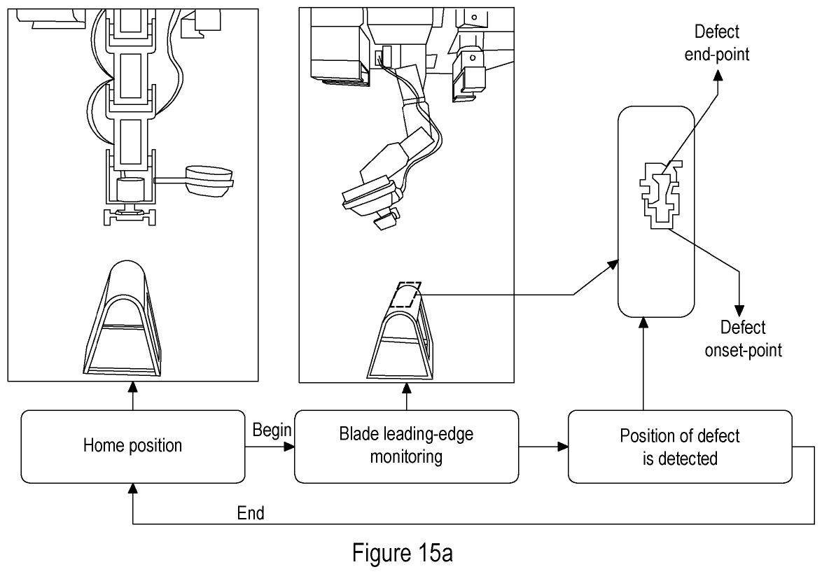

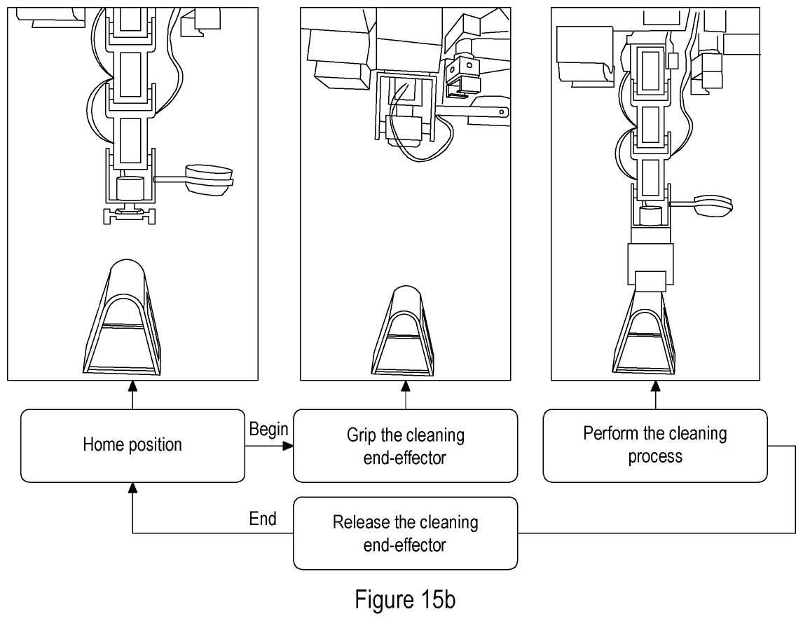

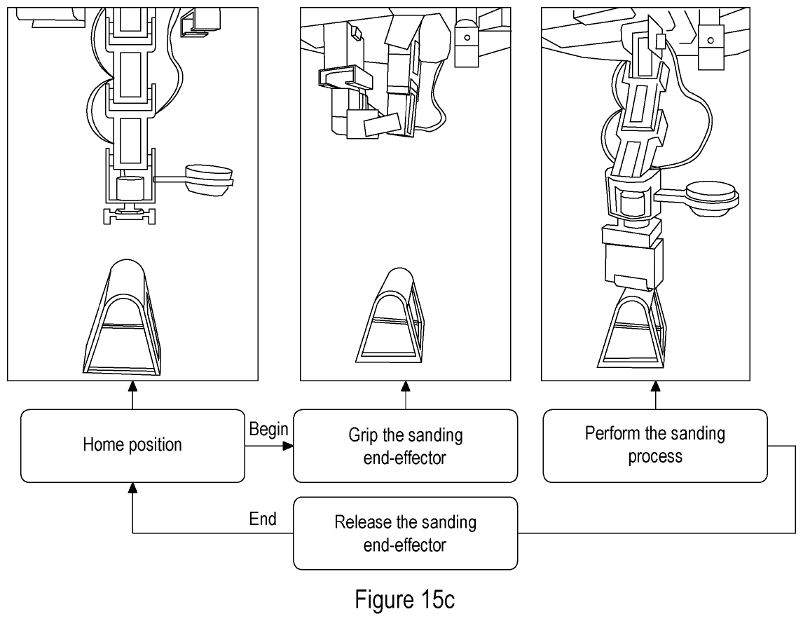

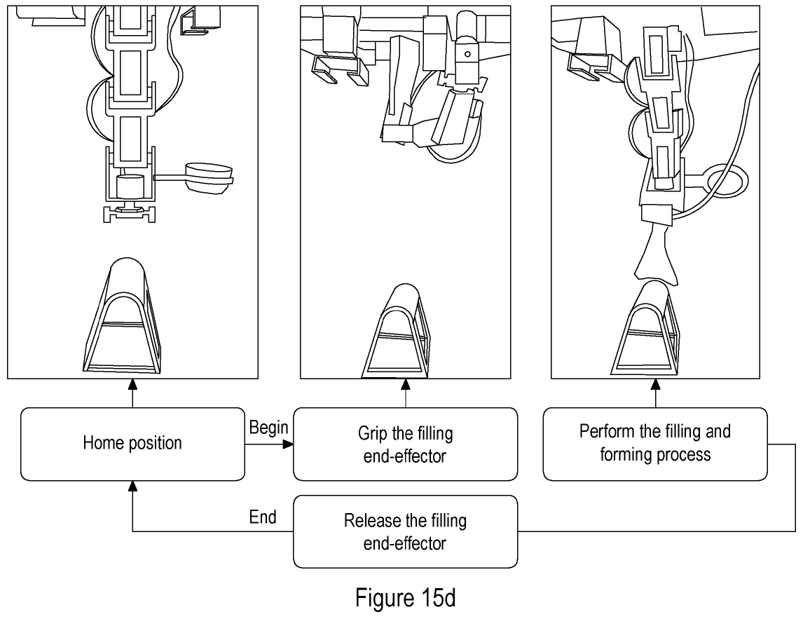

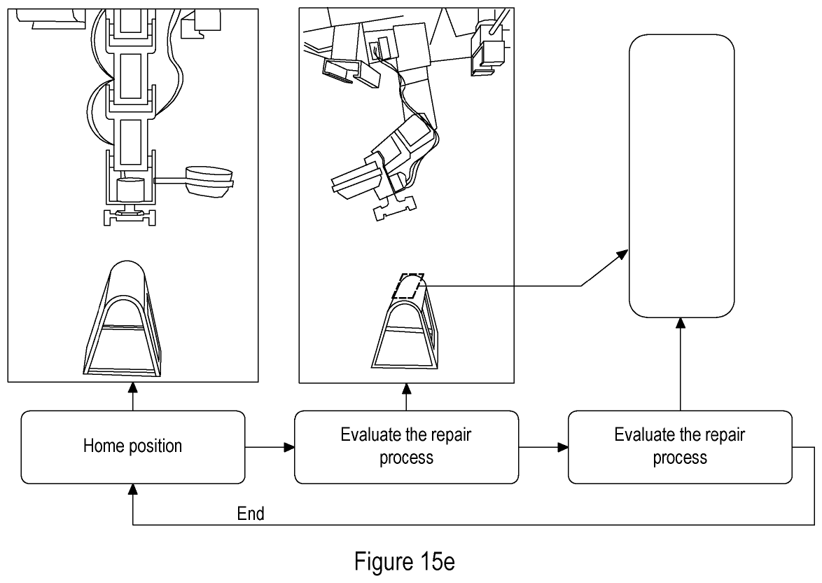

FIGS. 15a to 15e show the process of performing a repair procedure. In FIG. 15a in the first step the surface of a blade will be scanned to find the defects by using an erosion detection algorithm. Then the arm will be back returned to a Home position. The next step shown in FIG. 15b is a cleaning task. Accordingly the arm grips the cleaning end-effector and then the arm again comes back to the Home position to begin the process of cleaning. When the cleaning task is completed as approved by the operator then the arm takes back the cleaning end-effector to its predefined position within the toolbox by moving the arm into the corresponding storage slot of the toolbox, using the arm to deflect and open the end-effector storage module, releasing the cleaning end-effector repair tool when within the module and then retracting the arm.

All the presented process can be done autonomously and the operator acts as a supervisor to take control of the repair arm via the remote motion imitator via the user interface if any problem happens for its autonomous control system.

The other two sanding (FIG. 15c) and filling (FIG. 15d)-forming (FIG. 15e) process can be performed in the same manner as described above for FIGS. 15a and 15b. At the end of repair process, the repaired area will be scanned again to evaluate the repair and if the erosion detection algorithm can't detect any contour then it will send a command to the operator to finish the repair process.

Additionally communication with the robotic system may be undertaken using communication software. In the last three decades, increasing attention to safety in human's working environments and need to industrial mass productions are two major reasons for the widespread use of robots and automation systems. However, the initial progress in developing robots were very slow. One of the main reason of the proposed problem was lack of open-source standard programming libraries to be used to sensors reading and actuators controlling which caused to re-write them for each application. The complexity writing the mentioned libraries led to creation of various middleware to simplify the process of robots' software developing and low-level communication complexity. For example, middleware that most widely used to facilitate the process of developing various kinds of robots is Robot Operating System (ROS). In fact, ROS is not an operating system, but it is an open-source middleware which can provide the services like low-level controlling, package management, building environment, message routine and hardware abstraction which simplified the process of robots' software development.

The fast progress in broadband telecommunication technologies, increases need to wireless controlling, big data collection, processing and analyzing has grown the researchers' attention to use Internet based telecommunication system for robots. In 1995, Taylor and Trevelyan provided a web based control for a robotic arm to manipulate some colored blocks. Burgard and Schulz developed a predictive simulation for visualization to handle teleoperation delay of mobile robots. Goldberg et al. created a web based control system and allowed users to maintain a garden by interacting with the robot over web. Yinong et al. presents a cloud based framework to interact with robots in the area of service-oriented computing. Osentoski et al. proposed the rosbridge and rosjs to enabled users who hasn't familiar with ROS to interact with ROS topics and services using JavaScript. Alexander et al. presents a collection of open-source modules to coverage ROS with modern web and network technologies[ ]. Kubaa et al. developed an asynchronous cloud based communication protocol between the robot and users.

Despite of the advantages of the aforementioned Internet based telecommunication system, there are weaknesses like need to have access to public IP address to be accessible by Websockets clients in rosbridge or need to have access to cloud based services like ROSLink. Moreover, based on new approaches in multiple robotic systems control, smart resources management and telecommunication security, we need new facilities which can support them.

There have been done many researches about the Internet based telecommunication systems that can be applied for interacting with robots over the Internet. In the following the most related works to our research and their pros and cons will be described.

In 2011, Osentoski et al. presented rosbridge and rosjs. As it mentioned in, the main motivations behind rosbridge and rosjs are, to enable novice robot users to interact with a ROS based robot by using Internet browsers and to provide the possibility of develop client applications to communicate with ROS based robots by Web developers who has no knowledge in field of robotics. Rosbridge and rosjs were developed based on JavaScript programming language for web applications. Moreover, they used the version 1.0 of socket and version 2.0 of WebSocket to provide common interfaces for non-web clients. In order to use rosjs we need to create a rosjs object firstly to be able to interact with a ROS based system by using ROS services and topics. The main features of rosbridge and rosjs are ability to publish through a simple publish command, providing an additional abstraction level on top of ROS systems, ability to interact with ROS through TCP/IP or WebSocket connection and provides two methods of security, first, protecting services/topics and key authorization. According to structure of rosbridge, the Websockets server which is ran on the robot need a public IP address then the WebSocket client can have access to it. This issue couldn't be reached in all robots. Developing robot applications by using web browsers advantages includes, the web-browsers are simple to use and people are familiar by using them and because of using web browsers in all of operating systems, then developing web browsers based applications can increase the accessibility of them. In 2012 B. Alexander et al. presented Robot Web Tools (RWT), which allows web applications to interface with various robots that has middleware like ROS. RVVT uses rosbridge for messaging ROS topics in a client-server architecture and interact with users through web browsers. A principal goal of RVVT is to converge robot middleware like ROS with web based technologies to provide the possibility of accessing to cloud robotics for use over public area networks. In 2015, A. Casan et al. developed a Robotic Programming Network (RPN) in the context of a web-enabled ROS system to provide the possibility of remote education and training. In 2017 Koubaa et al. proposed ROSLink as a bridge between ROS and Internet of Things (IoT) to use for cloud robotics. In fact, ROSLink is as a communication protocol that enable the possibility of implementing specifications of client in the robot side, and manifestation of a proxy server which is set on a public IP server machine, like a cloud server. One of the main points about ROSLink is, its ability to define its own communication protocol between ROS and non-ROS users through the cloud. The main advantages of ROSLink cloud-based approach compare to the similar protocols like it can be regarded as, its independency from the robots' ROS master nodes, ability to communication between users and robots through the cloud, and effective management of robots, users and fundamental services. Due to the vast facilities of cloud services provides for their users, interesting in researches about cloud robotics has been increased currently. In 2019, Pereira et al. developed ROSRemote to helps users to work with ROS in a remote master based on a framework that give the possibility to create several applications that may run remotely on it. In 2020, Toffetti et al. presented an Enterprise Cloud Robotics Platform (ECRP), a Platform as a Service (PaaS) solution to build ROS-based cloud robotics applications. In spite of cloud services advantages for using as remote computing service or logged data storage, there are some concerns exist about them like, having continues access to them, privacy and security of storage data, and the support of services providers about their products.

ROS is an open-source meta-operating software which is created based on a collection of tools, libraries, and conventions that aim to simplify the process of creating complex and robust robot behavior across a wide variety of robotic platforms. ROS provides common interface that allow users to code sharing and reuse. The proposed features of ROS help robotic researchers and developers to concentrate on new innovation instead of spending time to writing the standard programming libraries again.

Moreover, it provides an abstraction layer to hardware resources and reveal the data obtained from the hardware parts as a labeled data stream which is named Topic.

ROS uses a peer-to-peer networking topology. The systems that are ROS based include a number of processes called nodes which are communicate with each other by sending messages. The ROSs' messages are simple data structures consist of typed fields. The communication between nodes will be done through ROS Master. The ROS Master main duties is to naming and registration services to rest of the nodes in ROS based system. In a ROS distributed network the master device will be considered as the ROS-core executer.

The main communication models between ROS nodes are, publish/subscribe and request/reply models. In the first communication model nodes exchanges topics, in this case one or multiple nodes may act as publisher(s) of a specific topic, and multiple nodes may subscribe to that topic, via the ROS Master. In the second ROS based communication model, one node will act as server which provide the service which is defined by using a pair of messages (one for the request and the other for reply) under a certain name, and process the received requests from other nodes as clients.

ROS is an open-source meta-operating software which is created based on a collection of tools, libraries, and onventions that aim to simplify the process of creating complex and robust robot behavior across a wide variety of robotic platforms. ROS provides common interface that allow users to code sharing and reuse. The proposed features of ROS help robotic researchers and developers to concentrate on new innovation instead of spending time to writing the standard programming libraries again.

Moreover, it provides an abstraction layer to hardware resources and reveal the data obtained from the hardware parts as a labeled data stream which is named Topic.

ROS uses a peer-to-peer networking topology. The systems that are ROS based include a number of processes called nodes which are communicate with each other by sending messages. The ROSs' messages are simple data structures consist of typed fields. The communication between nodes will be done through ROS Master. The ROS Master main duties is to naming and registration services to rest of the nodes in ROS based system. In a ROS distributed network the master device will be considered as the ROS-core executer.

The main communication models between ROS nodes are, publish/subscribe and request/reply models. In the first communication model nodes exchanges topics, in this case one or multiple nodes may act as publisher(s) of a specific topic, and multiple nodes may subscribe to that topic, via the ROS Master. In the second ROS based communication model, one node will act as server which provide the service which is defined by using a pair of messages (one for the request and the other for reply) under a certain name, and process the received requests from other nodes as clients.

Algorithm 1: Sending command from console to the manipulator

| | |
|---|---|
| 1. | Function sent (command): |
| 2. | Define: user api_id, api_hash and phone number, |
| 3. | Client = TelegramClient(phone, api_id, api_hash) |
| 4. | Client_connect |
| 5. | If not client_is_user_authoriaed( ) then |
| 6. | Client_send_code_request(phone); |
| 7. | Client_sign_in(phone, (‘Enter the code’)); |
| 8. | Client_start( ); |
| 9. | Destination_user_username=‘insert the client user name’; |
| 10. | Entity=client_get_entity(robot_user_username); |
| 11. | Client)send_message(entity, message=command); |
| 12. | Function main( ); |
| 13. | If container.txt>0 then |
| 14. | Command=read_container.txt( ); |
| 15. | Sign_1=command[0] |
| 16. | If sign_1==1 then->input command is related to switch button |
| | or joints |
| 17. | Sent(command[1]); |
| 18. | else |
| 19. | for (i=2; i<7; i++) do |
| 20. | Sent(command[i]); |

Control a Manipulator

In order to make a remote connection between the arm and the console, a secure internet-based communication system is designed and implemented.

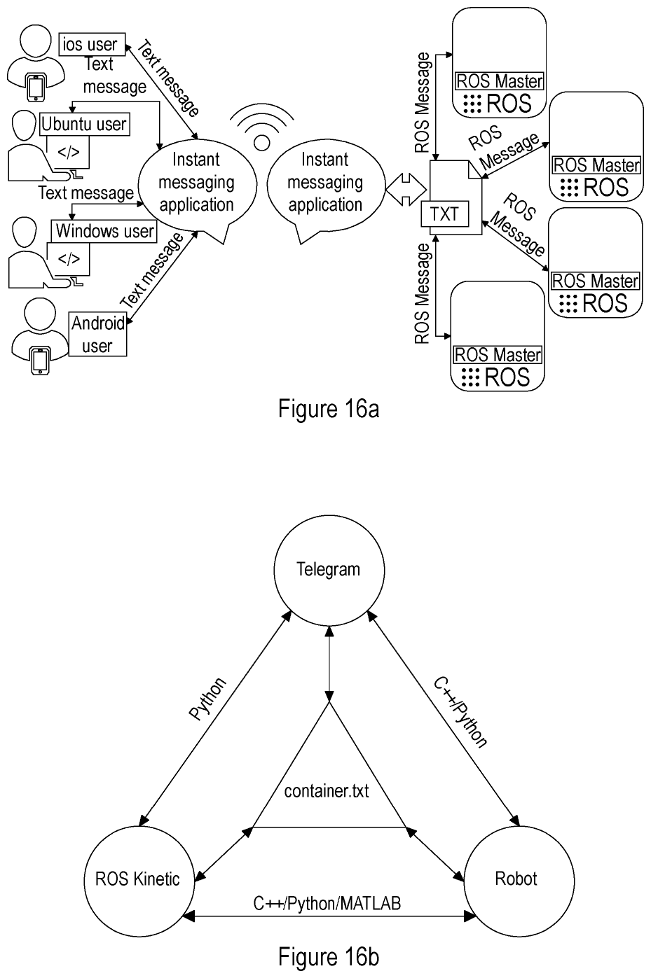

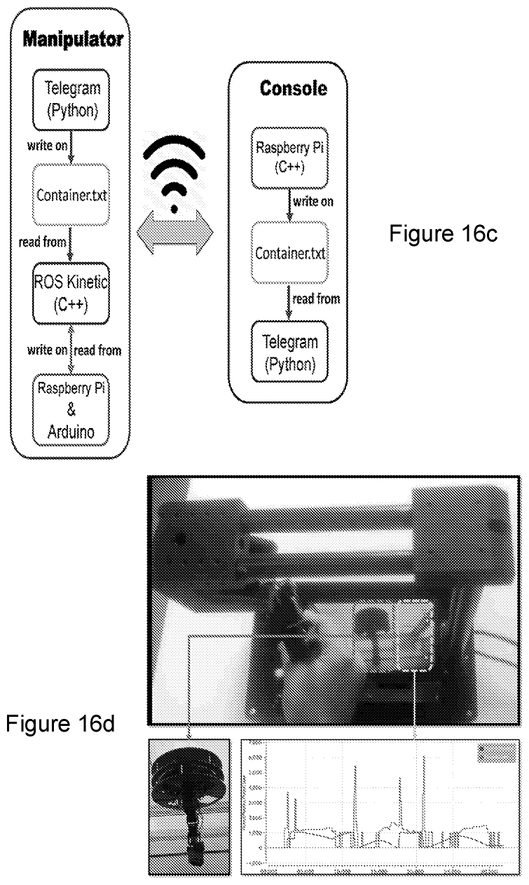

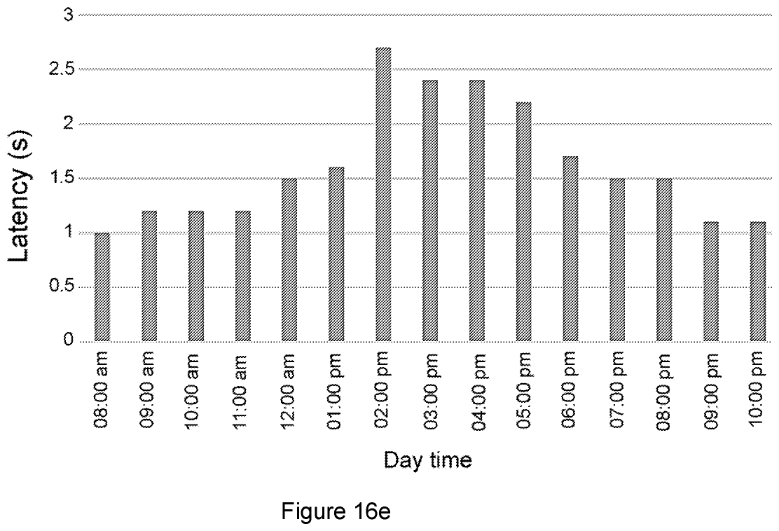

FIG. 16a illustrates the telecommunication concept using Telegram mobile application. As it is illustrated in FIG. 16b, ROSIC is a multi-languages communication system. In order to facilitate the communication between ROSIC subsystems a container which is a text file is provided to collect the output of each subsystem. Each subsystem can put its output in the container with a specific sign which is used for identification.

In the case that the operator push each of the console switch button a number and a sign will be sent to the Telegram application and then the proposed data will be sent to the arm as an executable command.

In Algorithms 1 and 2, the ‘api id’, ‘api hash’ and the phone number are three parameters used for user identification which can be obtained from the Telegram application, and they are unique. Moreover, as seen in Algorithm 1, the content of the ‘container.txt’ file will be monitored continuously, and any change in the content is checked against the commands for end-effector switch buttons or the console's imitation tool, which is used to detect the onset of commands array for reading. The output of Algorithm 2 will be saved in ‘container.txt’ file which is used as the input command to the ROS node used to control the arm.

The latency of the ROSIC system is calculated; the delay between the time of sending and receiving of the data over 4G mobile internet network is less than three seconds, which is acceptable for this project application. FIG. 16e—presents the latency in receiving the console commands by the arm, at 15 different times of the day. Said system may also utilize a stylus.

Algorithm 2: Receiving command from console and save in container.txt file.

| 1. | Function receive( ); | |
|---|---|---|
| 2. | Define: user api_id, api_hash and phone number; | |
| 3. | Client=TelegramClient(phone, api_id, api_hash)_start( ) | |
| 4. | Client_start( ) | |
| 5. | Destination_user_username==‘insert the user's name’; | |
| 6. | @client_on(events_NewMessage) | -> Check the command which are |
| 7. | Async def handler(event); | received from operator Telegram |

| | |
|---|---|
| 8. | Chat = await event_get_input_chat( ) |
| 9. | UI=chat_user_id |
| 10. | If(UI==user_id) then |
| 11. | Save even in container.txt |
| 12. | Client_run_until_disconnected( ) |

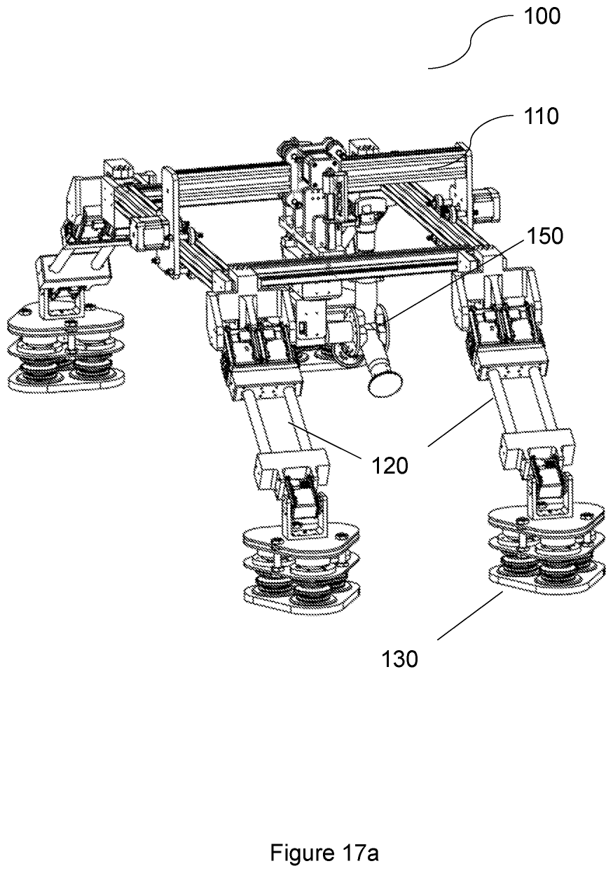

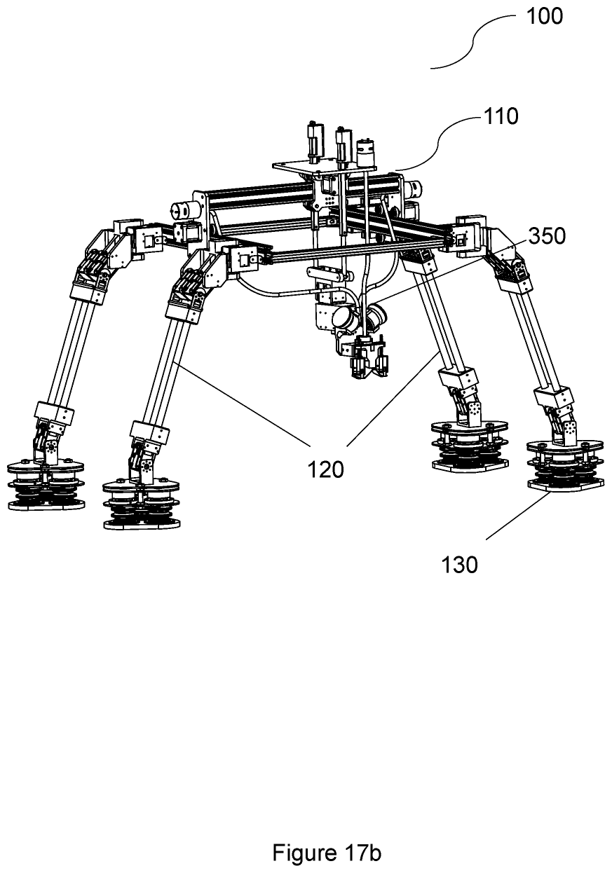

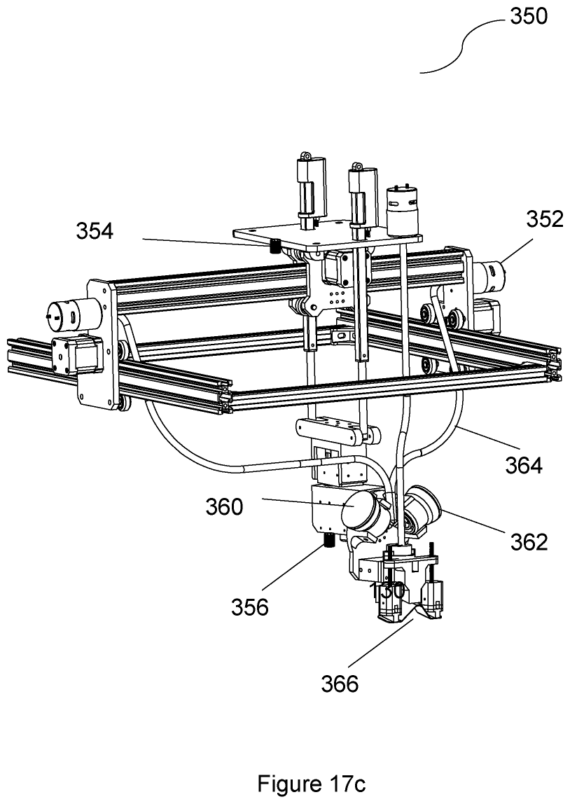

FIG. 17a shows an integrated robotic system 100 configured to attach to and move along wind turbine blades to perform maintenance and repair. The system comprises a base translation system 110, deployable legs 120 having attachment means 130, and a repair arm 150.

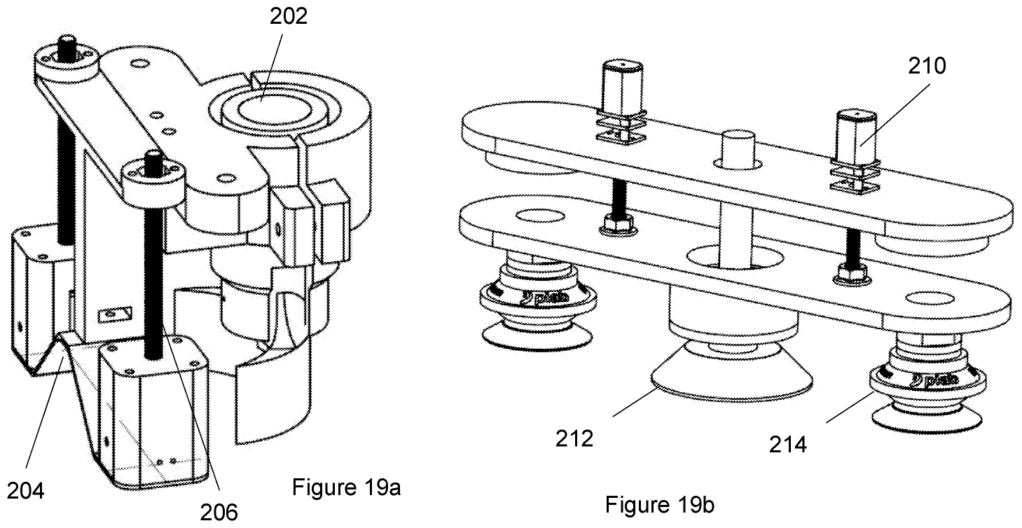

FIG. 17a shows the robotic system in a deployed position where the legs 120 are splayed out with the attachment means 130 secured to the turbine blades. The repair module 150 comprises an end effector selector system coupled to the repair module. The selector system in the example shown is a rotary system that can rotate to select a desired end effector repair or maintenance tool located at an end of a spur of the selector system. Example repair tools are shown in FIGS. 19a and 19b, and it can be appreciated that the repair tools described above can also be deployed on the end of any arm.

FIG. 17b shows the system 100 of FIG. 17a having a repair module 350 attached to the stage of the legs 120. The repair module 350 allows for autonomous detection, repair and evaluation of the surfaces. A DC motor 352 may be used to power the relative position of the module along the translation system 110. Although one motor is shown, further motors may be used. Cameras 354 and 356 allow for remote monitoring of the module during operation and aids in application of the repair tools during use. The repair module 350 comprises a rotary tool selection system having a plurality of repair tools that can be selected to be presented to the surface by rotating the rotary tool selection system to the desired repair tool. The repair tools comprise a rotary cleaning end-effector 360 of a similar manner to described previously. A rotary sanding end-effector 362 and a deposition nozzle 366 are also utilised. Flexible shafts 364 are used to control the repair tools.

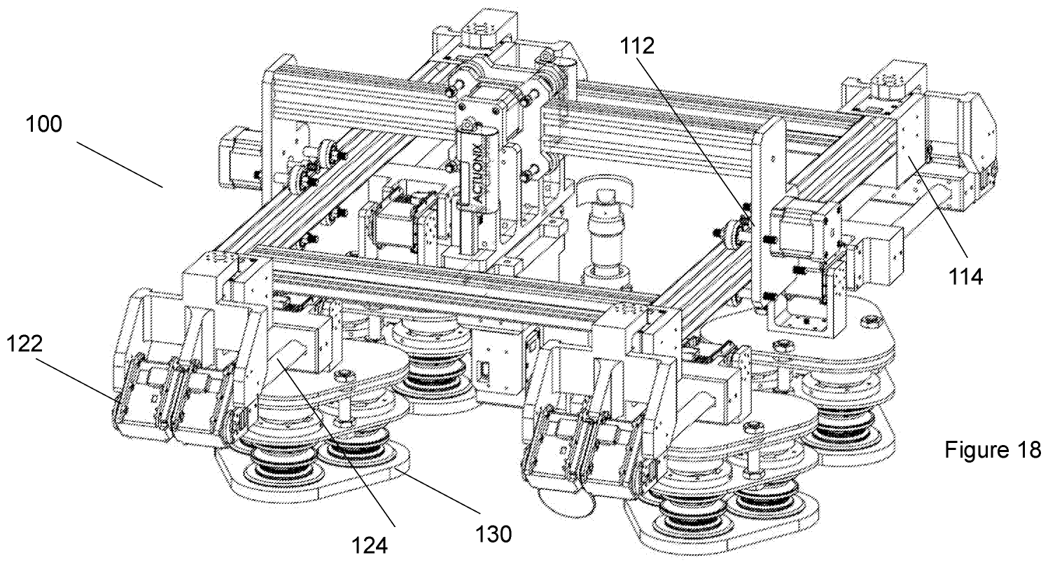

FIG. 18 shows the robotic system in a stowed or transport position. The base translation system 110 comprises a first translation stage 112 and a second translation stage 114. Each stage comprises connectors that allow for the repair arm 150 or repair system 350 to be translated both relative thereto and within the stage. The repair module 150 is coupled to the first translation stage and is translatable in a first single axis that allows the repair module to be moved within the stage to a position along an axis where the repair or maintenance can be performed. Additionally, the second translation stage is provided is coupled to the first translation stage and the first translation stage is translatable in a second axis, perpendicular to the first axis.

By utilising this two axis stage, the repair module and the associated end effector tools can be positioned at any point within the stage. FIGS. 19a and 19b show an autonomously adapting spatula 204 that enables conformation to the surface curvature for enhanced forming, and a stable platform, using suction cups 214 making for sanding and cleaning using surface-anchored rotational tools 212. Both end effector tools use a lead screw 206, 210 that allow the height of the tools to be adjusted. The autonomous spatula is an active system that can conform to the shape of the surface. For example, for a wind turbine leading edge, the autonomous spatula can adapt its curvature to the varying curvature of the leading edge to be able to recover the original leading edge curvature profile. The spatula can detect and measure the surface shape using a tactile sensor, micro-switches, ultrasonic sensor, or an optical sensor. The system has multiple containers to keep filler and cleaning materials.

In order for the robotic system to be moveable to a general location for repair/maintenance, the deployable legs are able to attach and release the turbine surface to allow the system to walk across the surface of the blade and into position.

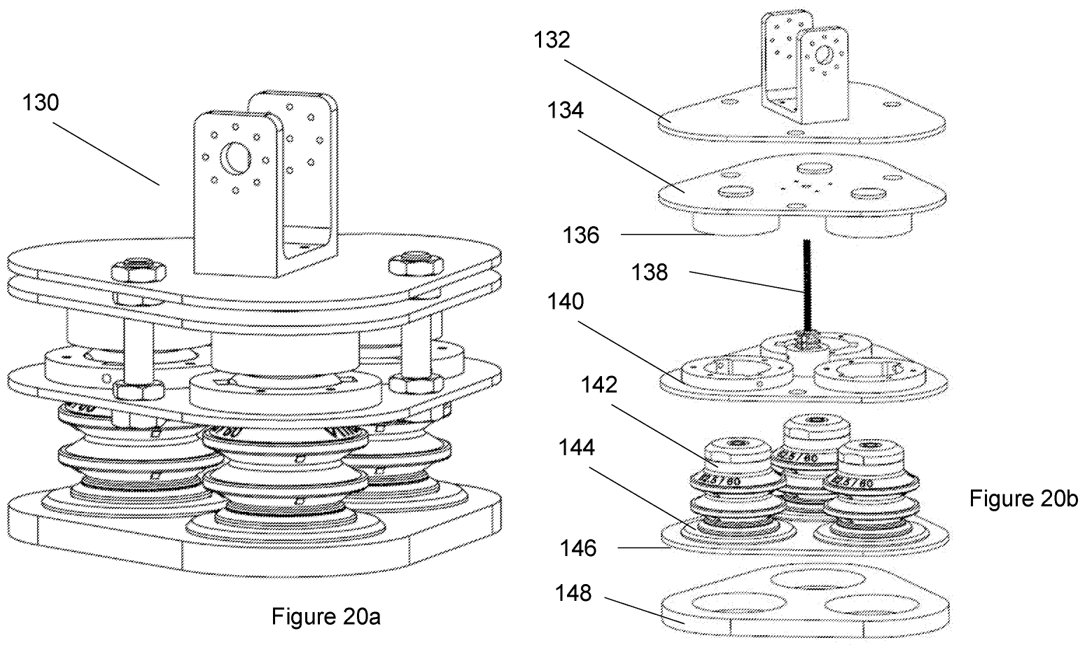

In order to attach to the surface the deployable legs are hingedly attached to the attachment means. The attachment means are shown in FIGS. 20a and 20b. In particular the attachment means 130 comprises a coupling 132 to secure the attachment means to the leg 120, a sliding plate 134, a sealing block 136 and a sliding plate lead screw actuator 138. The sealing block 136 comprises soft silicone cup inlets for receiving an end of suction cups 142 that pass through holes in a suction cup holder plate 140.

The example shown has 3 suction cups that are retained in the suction cup holder plate through a bayonet fitting about a neck of the suction cups 142. The suction cups 142 comprise a stopper 144 that are secured to the blade surface through a stopper hub 146 and a soft foam layer 148 that is placed on the surface. The foam layer is typically soft EPDM foam that allows conformation to the blade's curved surface.

Negative pressure may be used to engage and disengage the suction cups. This may include using a vacuum pump or using a compression mechanism for the suction cup as well as a sealing mechanism for the suction cup inlet. The above suction cup compression mechanism can either exploit the weight of the robot or be an active (motorised) compression mechanism.

From reading the present disclosure, other variations and modifications will be apparent to the skilled person. Such variations and modifications may involve equivalent and other features which are already known, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, and reference signs in the claims shall not be construed as limiting the scope of the claims.

1. An integrated robotic repair system for repairing a surface, said system comprising:
a base translation system, said system comprising a multistage platform;
a repair module, said module coupled to the translation system to move the module relative to the base translation system;
an end effector selector system coupled to the repair module, said selector system comprising end effector repair tools, each tool configured to undertake a repair task on the surface;
deployable legs, said legs coupled to the base translation system and configured to engage and disengage from the surface to allow the system to walk along surface.

2. The system of claim 1, wherein the deployable legs comprise attachment means for releasably engaging the repair system to the surface.

3. The system of claim 2, wherein the attachment means comprise suction discs.

4. The system of claim 3, wherein the suction discs comprise a plurality of suctions cups, said cups provided between an inlet sealing block and a contact surface sealing block.

5. The system of claim 4, wherein the suction cups are configured to engage the surface by compressing the inlet sealing block towards the contact surface sealing block.

6. The system of any one of claims 2 to 5, wherein the multistage platform comprises a first translation stage and a second translation stage, wherein the repair module is coupled to the first translation stage and is translatable in a first single axis.

7. The system of claim 6, wherein the first translation stage is coupled to the second translation stage and is translatable in a second single axis perpendicular to the first axis.

8. The system of any one of claims 2 to 7, wherein the deployable legs are hingedly attached to the attachment means.

9. The system of any preceding claim, where the surface may be a flat or curved surface.

10. The system of any preceding claim, wherein the repair module comprises a repair arm, said repair arm extending within the base translation system to present the end effector repair tool on the surface.

11. The system of any preceding claim, wherein the repair arm comprises a rotary tool selection system, said system rotatable to allow the desired end effector repair tool to be presented to the surface.

12. The system of any preceding claim, wherein
the end-effector repair tools comprise a cleaning end-effector for performing a cleaning task.

13. The system according to claim 12, wherein the cleaning end-effector comprises:
a controllable dispenser for metering cleaning liquid; and
a rotary cleaning device driven by a motor.

14. The system of claim 13, wherein the controllable dispenser further comprises:
a metering motor for actuating the dispenser, and wherein position information from the motor and metering motor allow control of a release rate of the cleaning liquid to the rotary cleaning device and a rotational speed of the rotary cleaning device according to the cleaning task.

15. The system according to any preceding claim, wherein the end-effector repair tools comprise a sanding end-effector for performing an abrasive task.

16. The system according to claim 15, wherein the sanding end-effector comprises a rotary sanding device driven by a motor.

17. The system according to any preceding claim, wherein the end-effector repair tools comprise a filler deposition end-effector for performing a filling task.

18. The system according to claim 17, wherein then filler deposition end-effector comprises:
an active mixer for mixing filler, said active mixer comprising a motor;
a nozzle for applying the filler to the blade according to the filling task, wherein the nozzle is a soft slit nozzle that conforms to the curvature of the blade; and
a proximity sensor for measuring a deposition thickness of the filler and to interrupt the motor once a desired thickness according to the filling task is reached.

19. The system of any preceding claim, wherein the repair module comprises a series of joints for moving manoeuvring the repair module relative to the base translation system, and wherein the system further comprises a toolbox for storing the plurality of end effector repair tools; and
wherein the repair module comprises a tool change mechanism located at a terminal end and configured to retrieve the repair tools from the toolbox and install them onto the module.

20. The system according to claim 19, wherein the toolbox comprises a retractable end-effector tool holder, said holder comprising resiliently biased jaws for holding one of the end-effector repair tools.

21. The system according to any preceding claim, wherein the system further comprises a casing for housing the toolbox, control electronics and any repair tool materials.

22. The system of claims 19 to 21, wherein the repair module comprises a mounting mechanism for installing the robotic repair system to a mobile robotic platform.

23. The system of claims 19 to 22, wherein the mobile robotic platform is an unmanned aerial vehicle or a crawler.

24. The system of claims 19 to 23, wherein the system further comprises a vacuum mounting for mounting the system to a surface.

25. The system of claims 19 to 24, wherein the plurality of joints comprise revolute joints, each revolute joint providing a rotational degree of freedom for the terminal end of the arm.

26. The system of claims 19 to 25, wherein the repair arm comprises a plurality of linkages, and wherein each revolute joint connects two linkages together.

27. The system of claim 26, wherein the repair arm comprises 5 revolute joints.

28. The system according to any of claims 19 to 27, wherein end-effector repair tools comprise a female connector and the tool change mechanism comprises a corresponding male connector for releasably retaining the end-effector repair tools.

29. The system according to claim 28, wherein the male connector is configured to retract to receive the female connector on the end-effector repair tool and is configured to extend to engage the female connector.

30. The system according to any preceding claim, further comprising one or more cameras for wirelessly transmitting visual images of performance of the repair system to a remote user.

31. The system according to any preceding claim, wherein the repair system comprises an imaging camera, and wherein the system comprises an image processing module for examining the surface for defects; and optionally or preferably wherein the system begins a repair task autonomously upon detection of defect.

32. The system according to any preceding claim, wherein the repair system is covered in a flexible protective sleeve; and optionally or preferably wherein the sleeve comprises one or more sleeve sensors configured to detect sheer strain in the sleeve indicative of the repair module being configured in a damaging orientation.

33. The system according to any preceding claim, further comprising a user interface for providing wireless control commands to the repair module by a remote user for transferring the remote user's tacit knowledge of the robotic repair process.

34. The system according to claim 33, further comprising a remote motion imitator for imitating movement of the remote control commands in a model of the repair module.

35. The system according to any preceding claim, wherein movement of the repair module through space is determined using one or more sensors.

36. The system of claim 35 wherein the sensor includes a collision detection sensor for detecting deleterious contact between the repair module and the blade and optionally or preferably wherein the collision detection sensor is an encoder on a motor of the system.
